(19) United States
(12) Patent Application Publication
(10) Pub. No.: US 2013/0065025 A1
(43) Pub. Date: Mar. 14, 2013

(54) SUBSTRATE HAVING ANIMATED FLASHING FIGURE, APPLICATION THEREOF AND MANUFACTURING METHOD OF THE SAME

(71) Applicant: KUN-MU LI, TAINAN CITY (TW)

(72) Inventor: KUN-MU LI, TAINAN CITY (TW)

(21) Appl. No.: 13/228,599

(22) Filed: Sep. 9, 2011

(51) Int. Cl. B32B 3/00; B29C 45/14; C25D 5/56

(52) U.S. Cl. 428/195.1; 205/164; 205/161; 264/279

(57) ABSTRACT

A substrate having animated flashing figures, applications thereof, and a manufacturing method of the same are revealed. A reflective film with an electroplated layer on a surface is covered over the base material. Then at least two figures are printed on the reflective film to form a printed layer. The figures are cut into strips and then the strips are arranged alternatively. Finally, a surface grating layer is arranged over the printed layer. Through the combination of the reflective film, the printed layer formed by staggered strips of the figures, and the surface grating layer, figures on a surface of the substrate show an animated flashing effect. The substrate can be applied to various products such as containers, trays, eyeglass frames, watch bands, etc.

### BACKGROUND OF THE INVENTION

1. Field of the Invention

The present invention relates to a substrate having animated flashing figures, application thereof, and a manufacturing method of the same, especially to a substrate, relevant applications and products on which figures show an animated flashing effect.

2. Description of Related Art

In early days, most of figures are printed directly on a substrate plate or a substrate sheet. Moreover, decorative patterns are coated on surfaces of stationary, ornaments, or cups by printing or transfer printing. These decorative patterns are 2-dimensional, without dynamic or flashing effect. Along with development of technology and increasing requirement for lift quality, such patterns are unable to satisfy customers and are eliminated. Thus there is room for improvement.

### SUMMARY OF THE INVENTION

Therefore it is a primary object of the present invention to provide a substrate having animated flashing figures, application thereof, and a manufacturing method of the same. The molding cost of the substrate is low. And the integrity of the figures is maintained while the substrate is used to manufacture products and the substrate is easy to be integrated with the product so as to provide animated and glaring effect.

In order to achieve the above object, a substrate having animated flashing figures includes a base material, a reflective film with an electroplated surface disposed over the base material, a printed layer printed on the reflective film, and a surface grating layer arranged over the printed layer. The printed layer includes at least two figures that are cut into strips and the strips are arranged alternatively. The arrangement period of gratings of the surface grating layer is corresponding to disposition period of each strip. By refraction of the surface grating layer, reflection of the reflective film, and a plurality of staggered strips on the printed layer corresponding to gratings of the surface grating layer, the figures have an animated flashing effect while users changing their viewing angles.

A manufacturing method of a substrate having animated flashing figures includes following steps. A reflective layer with an electroplated surface is covered over a base material. Then at least two figures are printed on the reflective film to form a printed layer. The figure are cut into strips that are arranged staggered to form a picture. A surface grating layer is disposed over the printed layer. Thus the figures on surface of the substrate are dynamic and flickering.

Moreover, the substrate having animated flashing figures are made into plastic products by plastic injection molding. Thus the plastic products have animated flashing figures on surface thereof.

A method of molding the plastic product includes a plurality of steps. Set a substrate having animated flashing figures in a mold of the plastic product. Then inject plastic into the mold and the plastic solidifies because. Next the mold opens and the plastic is ejected. The molded plastic products have dynamic flickering figures on the surface.

The above plastic product can be a container, a tray, an eyeglass frame, a watch band, etc.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment of a substrate according to the present invention;

FIG. 2 is a flow chart showing manufacturing steps of an embodiment of a substrate according to the present invention;

FIG. 3 is a cross sectional view of an embodiment of a substrate according to the present invention;

FIG. 4 is a schematic drawing showing an embodiment viewed at a certain angle according to the present invention;

FIG. 5 is a schematic drawing showing an embodiment viewed at another certain angle according to the present invention;

FIG. 6 is a cross sectional view showing a surface grating layer of an embodiment according to the present invention;

FIG. 7 is a perspective view of a surface grating layer of an embodiment according to the present invention;

FIG. 8 is a cross sectional view of another embodiment of a substrate according to the present invention;

FIG. 9 is a cross sectional view of a further embodiment of a substrate according to the present invention;

FIG. 10 is a flow chart showing steps of manufacturing a plastic product with a substrate having animated flashing figures according to the present invention;

FIG. 11 is a schematic drawing showing an embodiment of a substrate applied to a container according to the present invention;

FIG. 12 is a schematic drawing showing an embodiment of a substrate applied to a tray according to the present invention;

FIG. 13 is a schematic drawing showing an embodiment of a substrate applied to an eyeglass frame according to the present invention;

FIG. 14 is a schematic drawing showing an embodiment of a substrate applied to a watch band according to the present invention.

### DETAILED DESCRIPTION OF THE PREFERRED EMBODIMENT

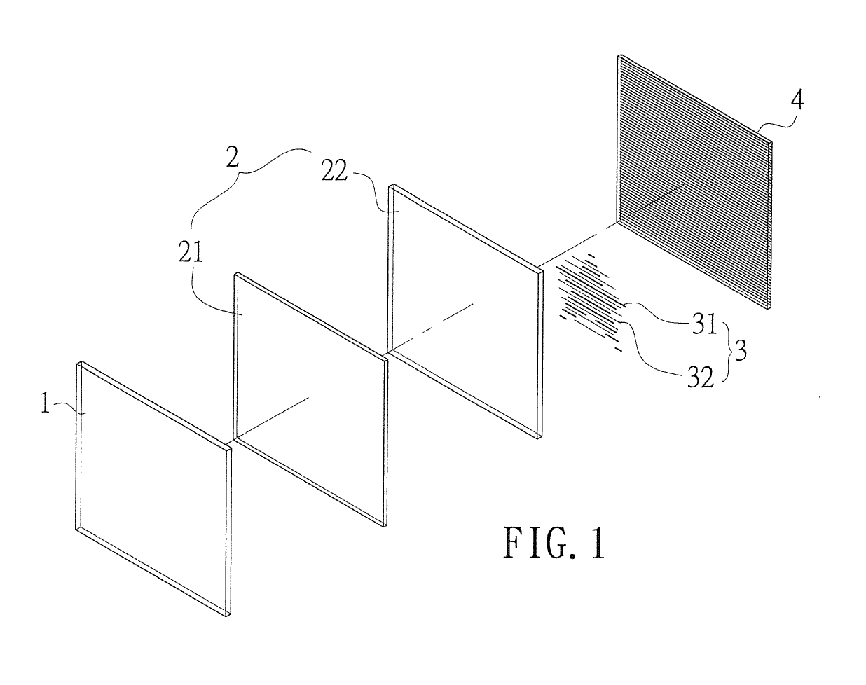

Refer to FIG. 1, a substrate mainly includes a base material 1, a reflective film 2 covered over the base material 1, a printed layer 3 being printed over the reflective film 2, and a surface grating layer 4 arranged over the printed layer 3. The printed layer 3 consists at least two FIGS. 31, 32 that are cut into strips and arranged staggered to form a picture. In an embodiment of the present invention, the two FIGS. 31, 32 are respectively a star and a circle. In the FIG. 1, the star and the circle are cut into strips and these strips are arranged alternatively. The orientation of the surface grating layer 4 (arrangement of gratings) is consistent with the direction of the strips that form figures of the printed layer 3. The periodic arrangement of the FIGS. 31, 32 is the same with the grating period. When the printed layer 3 includes three figures, the three figures are cut into strips and then arranged staggered with one another. Thus a picture made of horizontal strips is formed and each set of three strips from respective figures is within a corresponding grating. Even there are more figures, the strips of figures are arranged in a similar way.

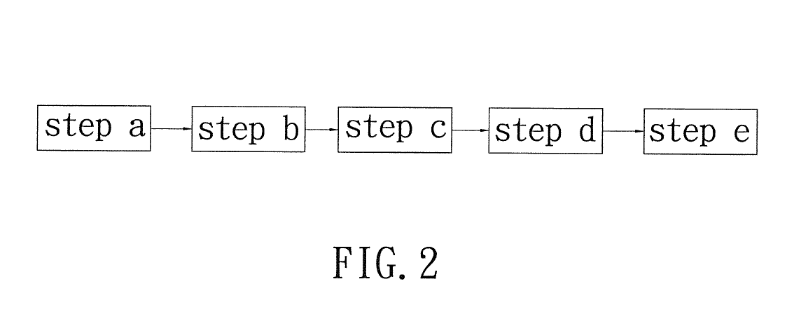

Refer to FIG. 2, a flow chart showing manufacturing processes of a substrate having animated flashing figures is revealed.

Also with reference to FIG. 1, the flow chart includes following formation steps:
(a) selecting one of following materials as a base material 1: polypropylene (PP) copolymer, acrylonitrile butadiene styrene (ABS) copolymer, polystyrene (PS) copolymer, polycarbonate (PC) copolymer, acrylic (Poly (methyl methacrylate, PMMA) copolymer, ethylene vinyl acetate (EVA) copolymer, foam made from PP, foam made from ABS, foam made from PS, foam made from PC, foam made from PMMA, and foam made from EVA.
(b) electroplating a plate 21 to produce a reflective film 2 with an electroplated layer 22 on a surface thereof; then another plate 21 is covered over the electroplated layer 22. The plate 21 is made from PP or polyethylene terephthalate (PET).
(c) covering the reflective film 2 over the base material 1.
(d) printing at least two FIGS. 31, 32 on the reflective film 2 to form a printed layer 3. The FIGS. 31, 32 are sliced into strips and arranged staggered.
(e) covering a surface grating layer 4 over the printed layer 3 and each of the strips of the FIGS. 31, 32 is arranged at an equal interval and is corresponding to each grating of the surface grating layer 4.

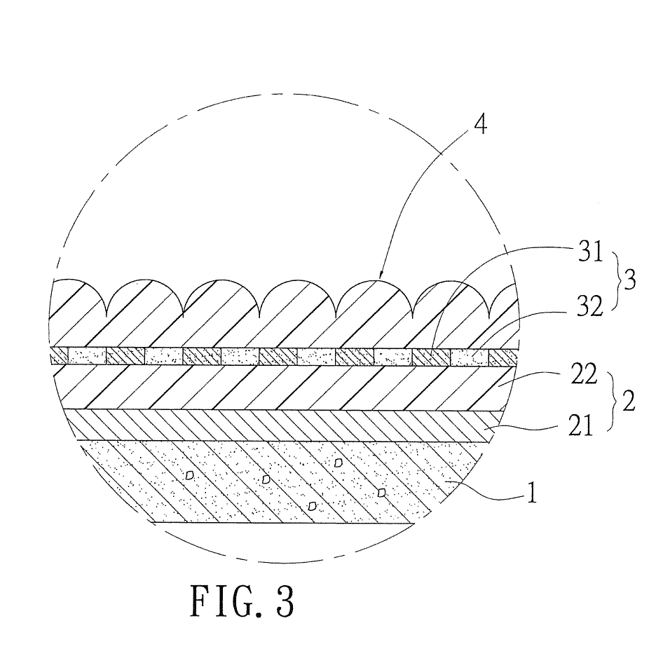

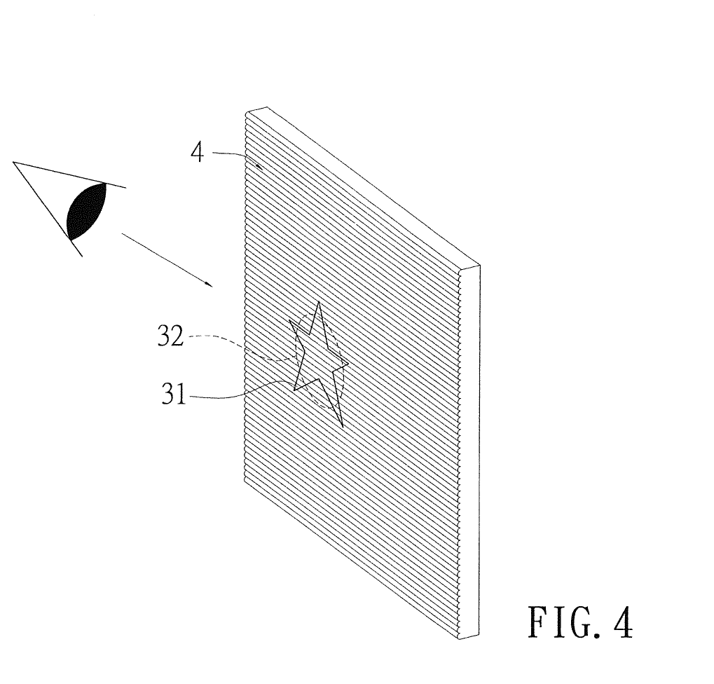

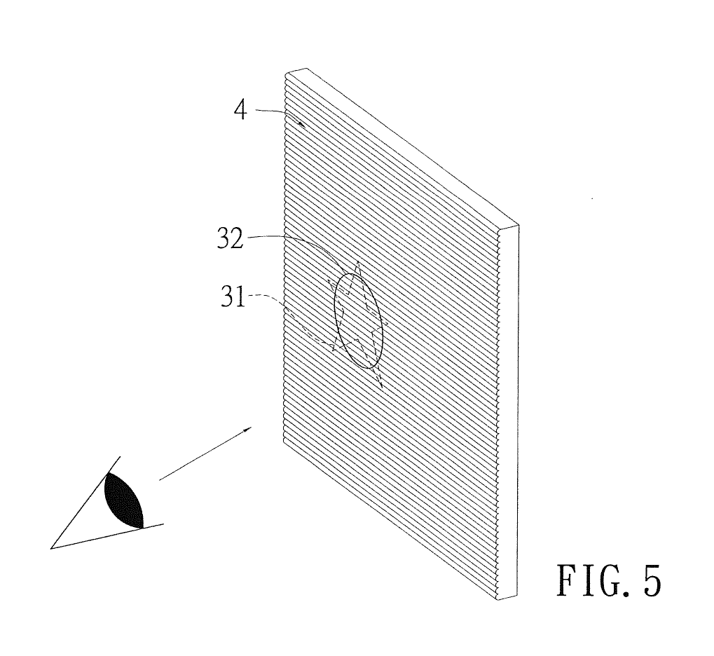

Thus the substrate having animated flashing figures shown in FIG. 3 and FIG. 4 is obtained through the above steps. By means of the refraction of the surface grating layer 4, the reflection of the reflective film 2 with the electroplated layer 22, together with the staggered strips of the printed layer 3, the figure observed is a flashing star 31 or a blinking circle 32 as shown in FIG. 4 and FIG. 5.

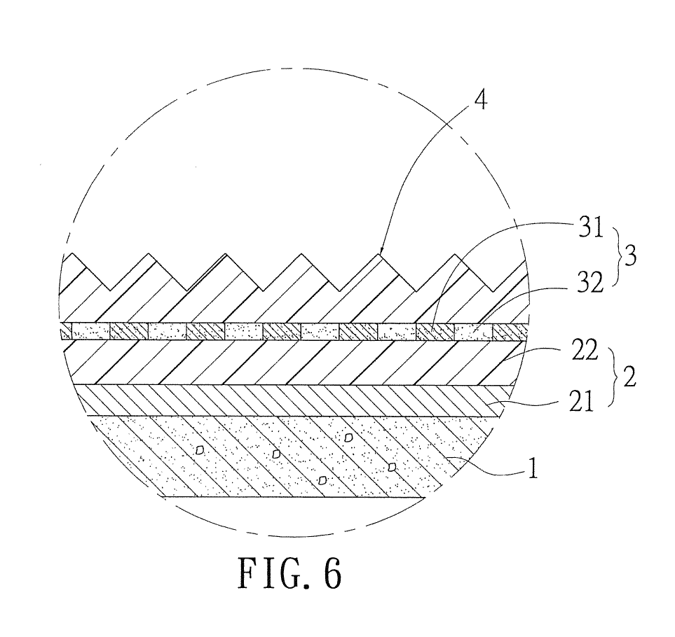

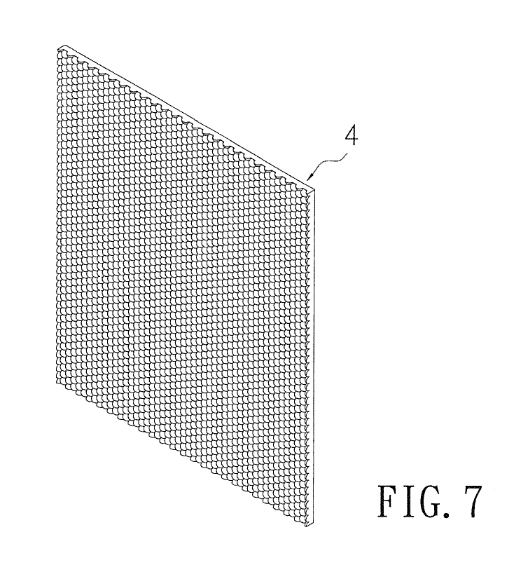

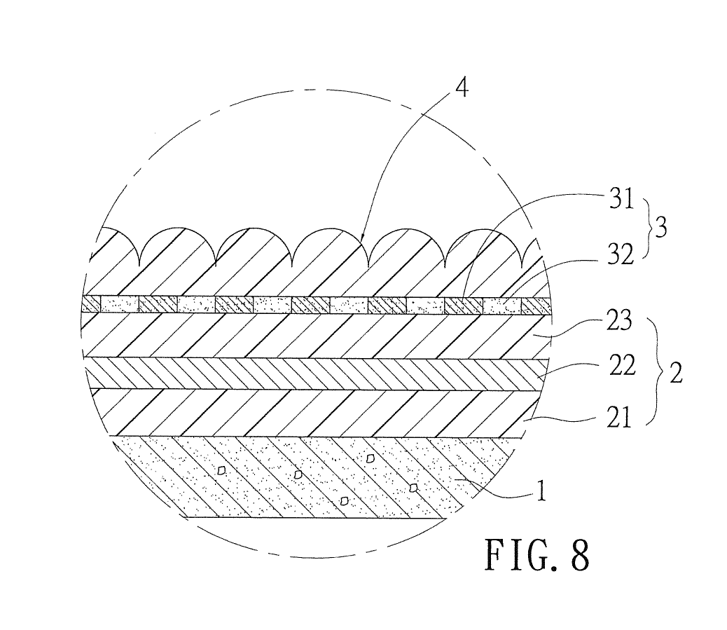

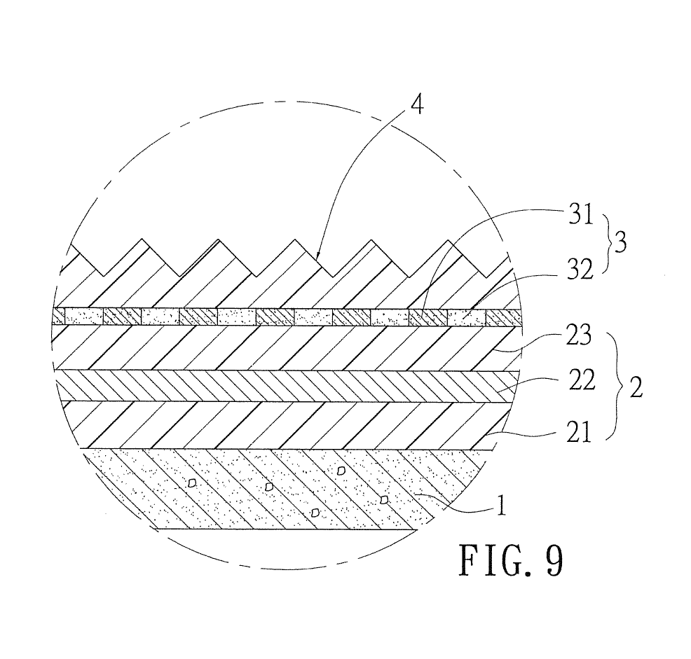

In an embodiment of the present invention, the gratings of the surface grating layer 4 are formed by a plurality of projecting strips having curved surfaces arranged at an equal interval (shown in FIG. 1, FIG. 3, and FIG. 8), a plurality of projecting strips having sawtooth surfaces arranged at an equal interval (shown in FIG. 6, and FIG. 9), or a plurality of small projections arranged at an equal interval (show in FIG. 7). Each strip of the figures is corresponding to and aligned with each projecting strip having the curved surface, each projecting strip having the sawtooth surface, or each particle. When the surface grating layer 4 is formed by the projecting strips having curved/sawtooth surfaces, the orientation of the grating layer 4 is consistent with the directions of the strips of FIGS. 31, 32 on the printed layer. Moreover, the distribution period of the FIGS. 31, 32 is the same with the period of the periodic arrangement of the projecting strips having curved surfaces, projecting strips having sawtooth surfaces, or the small projections. For example, when the printed layer 3 is formed by three figures, each set of three strips from respective figures is arranged staggered within each projecting strip having the curved surface, each projecting strip having the sawtooth surface or each small projection.

Refer to FIG. 8 and FIG. 9, the reflective film 2 is a film composed of a plate 21, an electroplated layer 22 formed over the plate 21 by electroplating, and another plate 23 arranged over the electroplated layer 22. The plates 21, 23 are made from PP or PET.

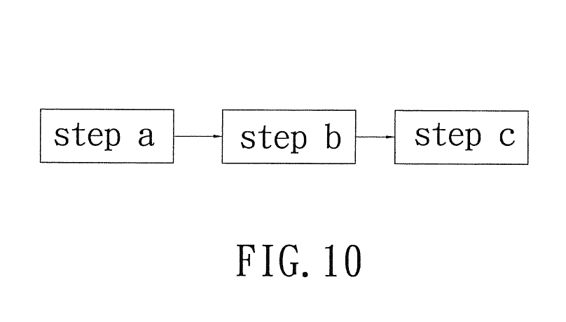

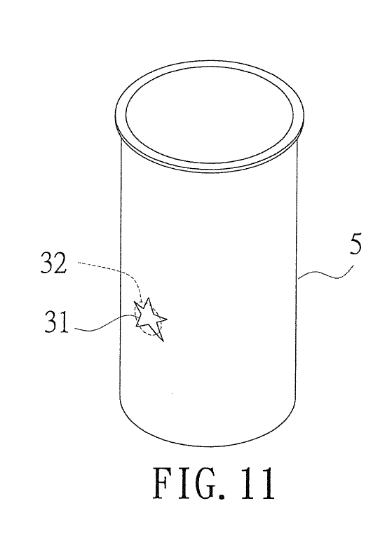

Refer to FIG. 10 and FIG. 11, in this embodiment, the substrate having animated flashing figures, together with plastic material, is made into a plastic product 5 by plastic injection over molding. The plastic product 5 has animated flashing figures on the surface thereof. The flow chart of manufacturing the plastic product 5 includes following steps.
(a) cutting a substrate having animated flashing figures into a shape corresponding to a molded plastic product 5;
(b) setting the cut substrate having animated flashing figures into a mold of the plastic product 5;
(c) injecting plastic into the mold of the plastic product 5 to integrate with the substrate having animated flashing figures so as to obtain the plastic product 5 having dynamic and flashing figures on surface thereof.

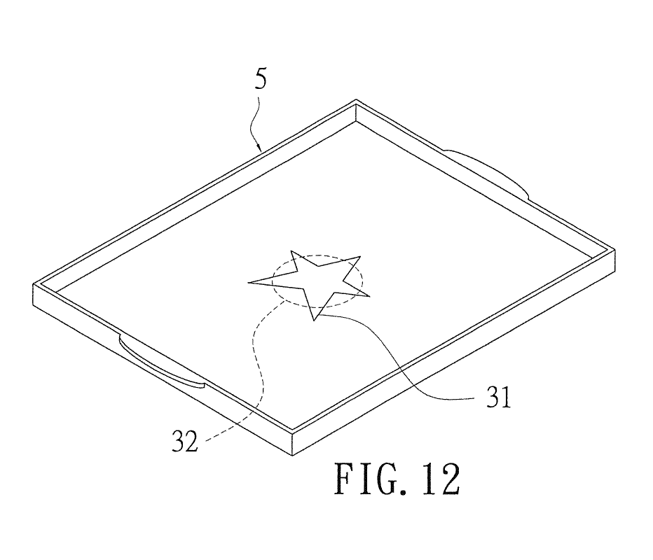

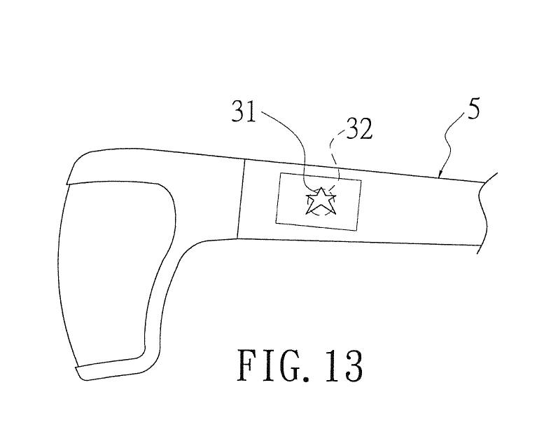

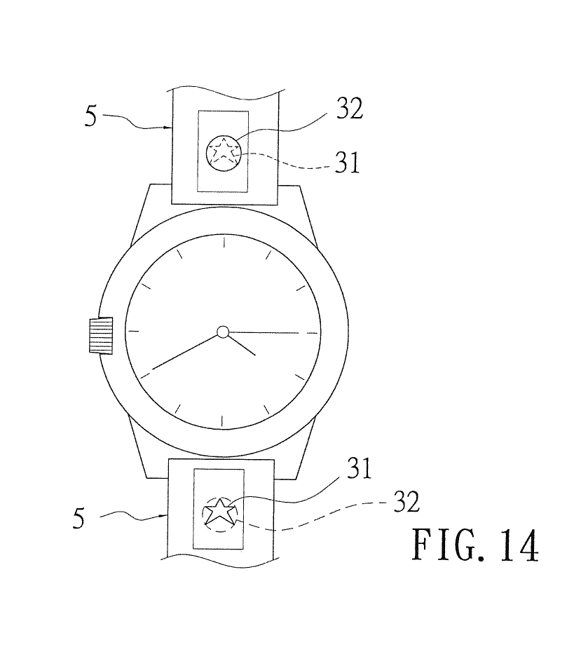

The plastic material of the plastic product 5 is selected according to the material of the base material (substrate). Refer from FIG. 10 to FIG. 14, the plastic product 5 can be a container, a tray, an eyeglass frame or a watch band.

When the plastic product 5 is made from PP, the material of the base material is PP or foam made from PP. If the plastic product 5 is a tray made from ABS or PS, the base material is ABS, PS, foam made from ABS or foam made from PS. When the plastic product 5 is an eyeglass frame made from PC or acrylic, the base material is PC, acrylic, foam made from PC or foam made from acrylic. When the plastic product 5 is a watch band made from EVA copolymers, the base material is EVA or foam made from EVA.

In summary, the present invention has following advantages:
1. The printed layer of the substrate includes at least two figures. The figures are cut into strips and the strips are staggered to form a picture. The surface grating layer is disposed over the printed layer. The distribution period of the staggered strips is corresponding to each projecting strip having curved/sawtooth surface or each particle. Thus by refraction of the surface grating layer, different figures are observed at different angles. In combination with the reflection by the reflective film electroplated on the surface of the base material, the user can see dynamic and glaring figures while changing the viewing angle.
2. Through the design of the present invention that the printed layer and the surface grating layer are corresponding to each other, there is no need to produce concave and convex patterns on the substrate for an animated flashing effect. Thus the manufacturing processes are simplified and the cost is reduced.
3. The material of the molded plastic product is the same with the material of the base material of the substrate having animated flashing figures. Thus the adhesion between the substrate having animated flashing figures and the plastic product is improved.
4. If the base material of the substrate having animated flashing figures is PP foam, the deformation of the animated flashing figures of the substrate during the plastic injection molding process can be avoided because the PP foam provides good heat insulation. Thus the yield rate of the plastic product is improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A substrate having animated flashing figures comprising:
a base material,
a reflective film disposed over the base material, a printed layer printed over the reflective film and the printed layer having at least two figures; the figures being cut into strips and arranged staggered to form a picture; and
a surface grating layer arranged over the printed layer; wherein arrangement of gratings of the surface grating layer is consistent with the direction of the strips of the figures and periodic arrangement of the strips of the figures is the same with a period of the gratings.

2. The substrate as claimed in claim 1, wherein the gratings of the surface grating layer are projecting strips having curved surface arranged at an equal interval, projecting strips having sawtooth surfaces arranged at an equal interval, or a plurality of small projections arranged at an equal interval.

3. The substrate as claimed in claim 2, wherein the reflective film is a plate with an electroplated layer formed over the plate by electroplating; the plate is made from polypropylene (PP) or polyethylene terephthalate (PET).

4. The substrate as claimed in claim 2, wherein the reflective film includes a plate, an electroplated layer formed over the plate by electroplating, and another plate arranged over the electroplated layer;
both of the plates are made from polypropylene (PP) or polyethylene terephthalate (PET).

5. A manufacturing method of a substrate having animated flashing figures comprising the steps of:
(a) selecting a base material;
(b) electroplating a plate to form a reflective film;
(c) covering the reflective film over the base material;
(d) printing at least two figures on the reflective film to form a printed layer and the figures being cut into strips and the strips arranged staggered;
(e) covering a surface grating layer over the printed layer and periodic arrangement of the staggered strips is corresponding to a period of gratings of the surface grating layer.

6. The method as claimed in claim 5, wherein the base material is selected from polypropylene (PP) copolymer, acrylonitrile butadiene styrene (ABS) copolymer, polystyrene (PS) copolymer, polycarbonate (PC) copolymer, acrylic (Poly(methyl methacrylate, PMMA) copolymer, ethylene vinyl acetate (EVA) copolymer, foam made from PP, foam made from ABS, foam made from PS, foam made from PC, foam made from PMMA, and foam made from EVA.

7. The method as claimed in claim 5, wherein the gratings of the surface grating layer are projecting strips having curved surface arranged at an equal interval, projecting strips having sawtooth surfaces arranged at an equal interval, or a plurality of small projections arranged at an equal interval.

8. The method as claimed in claim 7, wherein the reflective film is a plate with an electroplated layer formed over the plate by electroplating; the plate is made from polypropylene (PP) or polyethylene terephthalate (PET).

9. The method as claimed in claim 7, wherein the reflective film includes a plate, an electroplated layer formed over the plate by electroplating, and another plate arranged over the electroplated layer;
both of the plates are made from polypropylene (PP) or polyethylene terephthalate (PET).

10. A method of manufacturing plastic products by using a substrate having animated flashing figures comprising the steps of:
(a) cutting a substrate having animated flashing figures into a preset shape;
(b) setting the cut substrate having animated flashing figures into a mold of the plastic product; and
(c) injecting plastic into the mold of the plastic product to integrate with the substrate having animated flashing figures so as to obtain the plastic product having dynamic and flashing figures on surface thereof.

11. The method as claimed in claim 10, wherein the base material is polypropylene (PP) or foam made from PP if the plastic product is a container made from PP.

12. The method as claimed in claim 10, wherein the base material is acrylonitrile butadiene styrene (ABS), foam made from ABS, polystyrene (PS), or foam made from PS if the plastic product is a tray made from ABS or PS.

13. The method as claimed in claim 10, wherein the base material is Polycarbonate (PC), foam made from PC, acrylic or foam made from acrylic if the plastic product is an eyeglass frame made from PC or acrylic.

14. The method as claimed in claim 10, wherein the base material is ethylene vinyl acetate (EVA) copolymer or foam made from EVA copolymer if the plastic product is a watch band made from EVA copolymer.
